(19) United States
(12) Patent Application Publication
(10) Pub. No.: US 2014/0014584 A1
(43) Pub. Date: Jan. 16, 2014

(54) WASTEWATER PURIFICATION SYSTEM AND METHOD

(71) Applicants: Steven Wayne Cone, Fort Worth, TX (US); Robert Wayne Hayes, Morgan, TX (US)

(72) Inventors: Steven Wayne Cone, Fort Worth, TX (US); Robert Wayne Hayes, Morgan, TX (US); Stephen Michael Shiner, San Marcos, TX (US)

(21) Appl. No.: 13/642,484

(22) PCT Filed: Apr. 22, 2010
(86) PCT No.: PCT/US10/32074

§ 371 Date: Aug. 12, 2013

(51) Int. Cl. C02F 9/00

(52) U.S. Cl. CPC C02F 9/00
USPC 210/652; 210/295; 210/203; 210/806; 210/703; 210/663; 210/704; 210/665; 210/705; 210/667; 210/650

(57) ABSTRACT

Embodiments of the present disclosure provide a system and method for wastewater purification. The system may include a sludge filtration unit, a screen filtration unit, a multi-media filtration unit, and a soluble hydrocarbon filtration unit. The sludge filtration unit may remove impurities from wastewater. Impurities include hydrocarbons, suspended solids, and/or dissolved solids. The screen filtration unit may remove impurities from the wastewater. The multi-media filtration unit may remove impurities from the wastewater. The soluble hydrocarbon filtration unit may remove impurities from the wastewater.

### FIELD OF THE INVENTION

The present invention relates to wastewater purification. More particularly, the present invention relates to wastewater purification for oil and natural gas exploration and production.

### BACKGROUND

Oil and natural gas exploration and production generate wastewater through the use of techniques such as hydraulic fracturing. Hydraulic fracturing, or “fracing,” may involve the injections of more than a million gallons of water, particles, and chemicals at high pressure into wells as far as 10,000 feet below the surface. The pressurized mixture may cause cracks or fissures in the rock layer surrounding the well. These fissures may be held open by the particles so that natural gas or oil from the rock layer may flow up the well. The technique of hydraulic fracturing may be used to increase or restore the rate at which fluids, such as oil or gas, can be produced from a reservoir, including unconventional reservoirs such as shale rock or coal beds. Environmental concerns regarding hydrofracturing techniques include potential for contamination of aquifers with fracturing chemicals or waste fluids. Fracturing chemicals may include polymers, scale inhibitors, corrosion inhibitors, wetting agents (surfactants), antifreeze, methanol, and bactericides.

Oil and natural gas exploration and production may generate wastewater that includes flowback water, produced water, and pit water. Flowback water is water used to drill wells and improve efficiencies, especially through new drilling technologies. Flowback water may contain both dissolved and suspended solids, which vary with the chemical treatment. The dissolved solid of highest concentration may be chloride, which typically runs 2 to 4%, or 20,000 to 40,000 parts per million. Flowback water may include suspended solids, such as polymer constituents used as viscosifying agents that are long chain complex carbohydrates. Flowback water may contain dissolved solids that would cause down-hole scaling problems.

Produced water is water that comes to the surface from underground sources during drilling and production. Seven to nine barrels of produced water may be generated for a single barrel of oil or natural gas. Produced water may contain both dissolved and suspended solids, which vary with the producing reservoir. Limestone reservoirs produce wastewater high in calcium and magnesium, while sandstone reservoirs produce wastewater high in silica. All reservoirs have the potential to produce wastewater containing drilling solids residuals, including weighting agents such as barium and hematite (iron). Other potential problem-causing dissolved solids include sulfate, strontium, iron, manganese, fluoride, boron, and sometimes heavy metals (such as barium, strontium, chromium, copper, zinc, silver, and selenium) which can make disposal a problem. Produced water may have high dissolved chloride content, which can reach 16% concentration, or 160,000 parts per million. Produced water also has the potential to cause problems such as scaling when reintroduced into the well via fracturing operations, and can also interfere with the chemistry of the fracturing polymers. The dissolved solids in produced water that may create the most problems are calcium and magnesium, silica, fluoride, sulfate, barium, strontium, iron and manganese. Boron may create a problem if the treated water is to be discharged onto the ground or to a receiving waterway, as boron has a low limit of 0.5 parts per million.

Pit water typically contains drilling mud, such as barite-weighted, hematite-weighted, and clay (bentonite)-based drilling mud. Pit water typically contains lower levels of total dissolved solids (less than 10,000 parts per million) than produced and flow-back water. Pits are open to precipitation as well as “night-time dump stations” for illicit dumping if a pit site is unattended.

Oil and natural gas producers historically disposed of such wastewater through evaporation pits, surface discharge, wastewater plants, tank storage, and deep injection. As fresh water supplies reduced, regulations tightened, wastewater volumes increased, and disposal costs skyrocketed, historical methods for wastewater disposal became prohibitive from an economic, regulatory, environmental, and political standpoint. Such circumstances prompted some oil and natural gas producers to choose water recycling and purification rather than wastewater disposal.

Some of these oil and natural gas producers have experimented with various technologies such as ultrafiltration, reverse osmosis, thermal, and microwave to recycle their wastewater. Ultrafiltration is a variety of membrane filtration in which hydrostatic pressure forces a liquid against a semipermeable membrane. Suspended solids and solutes of high molecular weight may be retained, while water and low molecular weight solutes pass through the membrane. This separation process may be used in industry and research for purifying and concentrating macromolecular (10³-10⁶ Da) solutions. Ultrafiltration may not be fundamentally different from microfiltration or nanofiltration, except in terms of the size of the molecules it retains. Ultrafiltration may be applied in cross-flow mode, and separation in ultrafiltration may undergo concentration polarization. Reverse osmosis works by using pressure to force a solution through a membrane, retaining the solute on one side and allowing the pure solvent to pass to the other side. This is the reverse of the normal osmosis process, which is the natural movement of solvent from an area of low solute concentration, through a membrane, to an area of high solute concentration when no external pressure is applied. However, some oil and natural gas producers are not satisfied that advanced membrane filter technologies are economically viable.

### SUMMARY

Wastewater may destroy the membranes used by ultrafiltration and reverse osmosis technologies. Produced water with high levels of hardness can produce limestone-type scale that can clog membranes when combined with high alkalinity. Dissolved solids in produced water, such as chlorides, sodium, potassium, and sulfate, may create problems through the generation of high osmotic pressures if the produced water is to be desalinated via membrane treatment, such as ultrafiltration or reverse osmosis. The polymers in flowback water can quickly foul macro-filtration systems (sand, sock, cartridge and carbon filters), as well as micro, ultra and nanofiltration systems and reverse osmosis membranes. Dissolved solids may produce scaling of reverse osmosis membranes, limit discharge options and negatively affect fracturing gel chemistries. Suspended solids may produce fouling of filtration equipment and reverse osmosis membranes, as well as contaminate and/or plug disposal wells and producing wellbores. Hydrocarbons contained in produced fluids, which may act as carrier agents for fracturing gels, can permanently foul filtration and reverse osmosis equipment. Replacement of these expensive membranes may result in making the use of such technologies cost prohibitive. Clay filtration systems and ion exchange filtration systems may remove hydrocarbons that destroy membranes, but the use of such filtration systems may be too expensive, thereby substituting one excessive expense for another.

Embodiments of the present disclosure provide a system and method for wastewater purification that can economically purify wastewater from thick muddy slurry to a bottled-water quality for reuse or discharge into the environment. Each wastewater batch may be treated differently by using a specific combination of filtration units based on the pollution level and contents, as well as the customers' desired end product specifications. The purification process may be stopped at any point in the process depending on the purified water usage required by customers. The system may include a sludge filtration unit, a screen filtration unit, a multi-media filtration unit, and a soluble hydrocarbon filtration unit to remove impurities from the wastewater. Impurities include hydrocarbons, suspended solids, and/or dissolved solids. The sludge filtration unit may remove a first set of impurities from wastewater. The screen filtration unit may remove a second set of impurities from the wastewater. The multi-media filtration unit may remove a third set of impurities from the wastewater. The soluble hydrocarbon filtration unit may remove a fourth set of impurities from the wastewater. The processed wastewater may be further processed by techniques such as ultrafiltration and reverse osmosis because embodiments of the present disclosure economically may remove the vast majority of the impurities that may damage the membranes used by such techniques. Oil and gas production companies may use embodiments of the present disclosure to recycle water at or below current disposal costs, protect the environment and health of citizens, reduce the volumes of fresh water needed for exploration and production, overcome negative public perceptions, and improve their public image

The present invention solves these and many other problems associated with wastewater purification.

Therefore, it is an object of the present invention to provide an economically viable solution for wastewater purification.

It is another object of the present invention to provide an environmentally friendly solution for wastewater purification that protects the health of people and animals.

It is yet another object of the present invention to provide a solution for wastewater purification that overcomes negative public perceptions and improves the public image of oil and natural gas producers.

It is another object of the present invention to provide a solution for wastewater purification that may be customized for each customer based on the levels of impurities in the customer's wastewater arid/or the customers' desired end product specifications.

### BRIEF DESCRIPTION OF THE DRAWINGS

The invention will be better understood with reference to the drawings taken in connection with the detailed description which follows:

FIG. 1 is a view of a block diagram of an exemplary system of the present invention; and

FIG. 2 is a flowchart of an exemplary method of the present invention.

### DETAILED DESCRIPTION

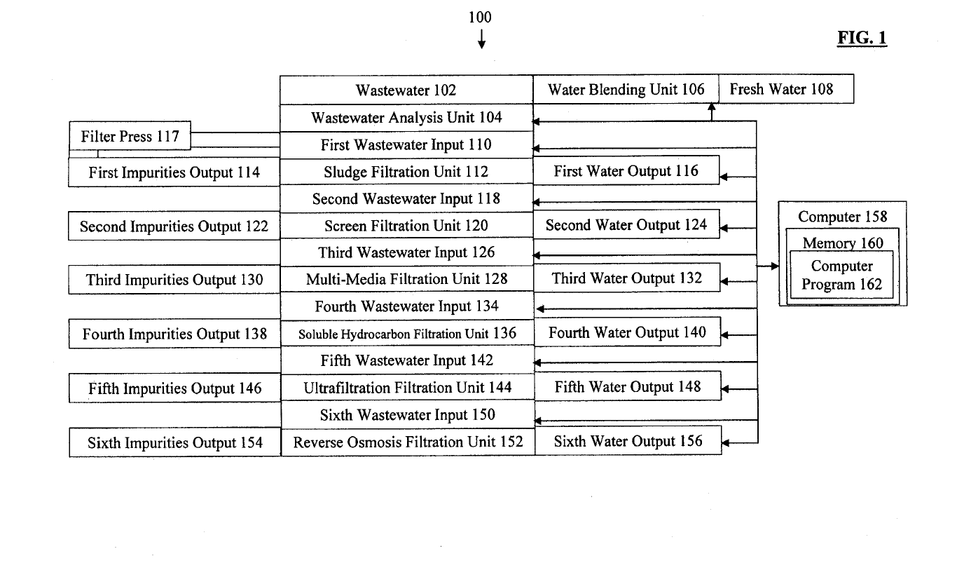

FIG. 1 presents a sample system 100 of the present disclosure. The system 100 includes wastewater 102, a wastewater analysis unit 104, a water blending unit 106, fresh water 108, a first wastewater input 110, a sludge filtration unit 112, a first impurities output 114, a first water output 116, a filter press 117, a second wastewater input 118, a screen filtration unit 120, a second impurities output 122, a second water output 124, a third wastewater input 126, a multi-media filtration unit 128, a third impurities output 130, a third water output 132, a fourth wastewater input 134, a soluble hydrocarbon filtration unit 136, a fourth impurities output 138, and a fourth water output 140. The system 100 may also includes a fifth wastewater input 142, an ultrafiltration filtration unit 144, a fifth impurities output 146, a fifth water output 148, a sixth wastewater input 150, a reverse osmosis filtration unit 152, a sixth impurities output 154, a sixth water output 156, a computer 158, a memory 160, and a computer program 162. The inputs 110, 118, 126, 134, 142, and 150, and the outputs 116, 124, 132, 140, 148, and 156 may be implemented as valves. The computer program 162 is stored in the memory 160 and may be executed by the computer 158 to communicate with the elements 104, 106, 110, 116, 118, 124, 126, 132, 134, 140, 142, 148, 150, and 156 in the system 100. The system 100 may be fixed as a whole at a specific geographic location, or the elements 102-162 may be modular components that enable the system 100 to be sufficiently portable to be used at multiple geographic locations. Although FIG. 1 depicts one of each of the elements 102-162, the system 100 may include any number of each of the elements 102-162, as well as additional elements that are not depicted in FIG. 1. For example, the system 100 may include multiple sets of the elements 118-156, wherein each set of the elements 118-156 processes the wastewater 102 in parallel after the wastewater 102 exits the sludge filtration unit 112. The system 100 may process the wastewater 102 through multiple sets of the elements 118-156 to improve a throughput rate and provide redundancy of the elements 118-156 for repair and maintenance purposes.

The water analysis unit 102 may analyze the wastewater 102, regardless of whether the wastewater 102 is to be disposed of or recycled for use. Based on this wastewater analysis, a user of the system 100 may be able to inform an oil and natural gas exploration and production customer of the estimated costs for purifying the wastewater 102 based on the customer's expected use standards. For example, the water analysis unit 104 analyzes the wastewater 102 to measure the amounts of dissolved solids, suspended solids, hydrocarbons, and bacteria. The dosages of the treatment chemicals may change based upon the concentration of suspended and dissolved solids in the water to be treated. The system 100 treats the wastewater 102 as “batches,” as variations in dissolved solids concentration may cause constant adjustment for chemical feed rates, as well as fluctuation in membrane treatment pressure. A fluctuation in membrane treatment pressure may make determining the cause of pressure changes difficult, i.e., the trans-membrane pressure may increase due to either fouling and/or scaling or due to higher concentrations of dissolved solids.

The water analysis unit 104 may enable the system user to compare preliminary certified lab results of wastewater samples with field bench-top tests of the wastewater 102 to verify whether the wastewater 102 is analogous to the submitted wastewater samples. Alternatively, the system 100 may purify the wastewater 102 based on certified lab results of wastewater samples without analysis by the wastewater analysis unit 104. The customer may supply representative samples or valid analyses of the wastewater 102 to be treated. Once the wastewater 102 is analyzed, bench top testing and modeling may confirm system capabilities to chemically treat the wastewater 102. After the wastewater 102 is analyzed, or wastewater samples are tested, the system user may be able to establish the customer's water criteria and submit a pretreatment schedule that meets the customer's satisfaction.

The water blending unit 106 may blend the fresh water 108 with the wastewater 102 based on analysis conducted by the wastewater analysis unit 104. For example, the water blending unit 106 may blend the fresh water 108 with the wastewater 102 prior to the system 100 adding any chemicals to the wastewater 102 if analysis conducted by the wastewater analysis unit 104 indicates that the wastewater 102 needs to be blended with the fresh water 108 to facilitate achievement of the customer's desired end use product.

The wastewater 102 may enter the sludge filtration unit 112 via the first wastewater input 110, which may be controlled by the computer 158. The sludge filtration unit 112, which may be a 300 gallons-per-minute dissolved air flotation unit, a clay filtration unit, or an alternative filtration unit, removes a set of impurities from the wastewater 102 via the sludge filtration unit 112. A dissolved air flotation (DAF) unit uses a water treatment process that clarifies wastewaters (or other waters) by the removal of suspended matter such as hydrocarbons, dissolved solids, and/or suspended solids. A dissolved air flotation unit may neutralize the charges on suspended solids, which are generally negatively charged, via the addition of a strongly cationic (+2 or +3 charge) chemical, such as aluminum or iron salts, or organic-based coagulants. The neutralized particles no longer repel each other, and come together and agglomerate to form sufficient mass to settle out of solution. To enhance the settling rate, a flocculent or coagulant can be added, either by a dissolved air flotation unit or upstream of a dissolved air flotation unit. The system 100 may include a fracing tank that holds fracing water, which is a form of the wastewater 102, upstream of or in place of a dissolved air flotation unit. The system may use a batch mixer, a chemical blender, a chemical pump, and/or a screen processor to add a flocculent or coagulant upstream of or in place of a dissolved air flotation unit. A flocculent or a coagulant is a high molecular weight polymer which binds the neutralized particles together to increase the agglomerated particles weight to decrease the settling time. The removal of the suspended matter may be achieved by the dissolved air flotation unit dissolving air in the wastewater 102 under pressure and then releasing the air at atmospheric pressure in a flotation tank or basin. The released air forms tiny bubbles which adhere to the suspended matter in the wastewater 102, causing the suspended matter to float to the surface of the wastewater 102, where a skimming device may remove the floating impurities. A dissolved air flotation unit is often used in treating the industrial wastewater effluents from oil refineries, petrochemical and chemical plants, natural gas processing plants and similar industrial facilities. In the oil and natural gas industry, a dissolved gas flotation unit may not use air as the flotation medium in some situations due to the explosion risk. Natural gas and other types of gas may be used instead to create the bubbles. For example, the sludge filtration unit 112 injects natural gas into the wastewater 102 to remove entrained hydrocarbons from the wastewater 102.

The wastewater 102 that enters a dissolved air flotation unit may be dosed with a coagulant and/or a flocculent (such as ferric chloride or aluminum sulfate) to flocculate the suspended matter, thereby creating clarified effluent water below the surface of the wastewater 102. Examples of coagulants and flocculents include alginates, alum, aluminum chlorohydrate, aluminum sulfate, calcium oxide, calcium hydroxide, chitosan, ferric chloride, gelatin, guar gum, iron sulfate, iron chloride, isinglass, moringa oleifera, polyachrylamide, polyDADMAC, sodium aluminate, sodium silicate, and strychnos. The metered amounts of the coagulant and/or flocculent that the sludge filtration unit 112 adds to the wastewater 102 may be based on the wastewater analysis conducted by the wastewater analysis unit 104, or the certified lab results, to enable hydrocarbons, dissolved solids, and suspended solids to be captured molecularly and floated to the top of the wastewater 102. A portion of the clarified effluent water leaving a dissolved air flotation unit may be pumped into a small pressure vessel (called an air drum) into which compressed air is also introduced. This may result in saturating the pressurized effluent water with air. The air-saturated water stream may be recycled to the dissolved air flotation unit and flow through a pressure reduction valve just as it enters the dissolved air flotation unit, which results in the air being released in the form of tiny bubbles. As described above, the bubbles may adhere to the impurities, or suspended matter, causing the suspended mater to float to the surface of the wastewater 102 and form a froth layer which is then removed by a skimmer, and the processed wastewater 102 may be drawn off for treatment via a polishing filter, prior to discharge. A dissolved air flotation unit may use a ventilation system to remove some gases via in the filtration processes. Some dissolved air flotation units utilize parallel plate packing material to provide more separation surface and therefore to enhance the separation efficiency of the units. The rate at which the wastewater 102 flows through the sludge filtration unit 112 may be adjusted based on wastewater analysis conducted by the wastewater analysis unit 104 because of the treatment time for the wastewater 102 to react to the metered amounts of the coagulant and/or the flocculent.

After the sludge filtration unit 112 processes the wastewater 102, the sludge filtration unit 102 may output the sludge via the first impurities output 114. If not hazardous, the sludge may be recycled, disposed of via a landfill, or disposed of via other means of disposal. Because landfills may not accept sludge containing free water, sludge must be dewatered via belt, filter or vacuum press, or centrifuge. Therefore, the first impurities output 114 may direct the sludge to the filter press 117 so that water may be extracted from the sludge and a viable commercial hydrocarbon product may be reclaimed from the sludge, leaving a disposable byproduct. One of skill in the art will recognize that any type of filter press or similar apparatus may be used for reclaiming water and/or hydrocarbons from sludge. For example, the filter press 117 may consist of a series of filter chambers containing square, rectangular or round filter plates supported in a frame. Once the filter chambers are loaded with sludge, the filter plates are forced together with hydraulic rams that may have pressures in the region of 100 pounds per square inch (70,000 kg per m2). The filter press 117 may work in a “batch” manner wherein the filter press 117 loads with sludge before completing a filtering cycle and produces a batch of solid filtered material, called the filter “cake,” a disposable by product, and once the solid cake is removed, the filter press 117 re-loads with sludge and the filtering cycle repeats. The filter press 117 may use increased pressure to maximize the rate of filtration and produce a final filter cake with low water content. In addition to the filter plate filtration medium, the growing filter cake enhances removal of fine particles in the sludge. The solution coming through the filter press 117 may be called the filtrate, and may be drained away for safe disposal, the filtrate may be kept in a water tank for recycled use, or the filtrate may be redirected to the sludge filtration unit 112. At the end of filtration, the solid filter cake may be removed. The filter cake may be disposed of at a lower cost than the disposal cost of the sludge. The filter press filtration process may be controlled by the computer 158 to make the process automatic or semi-automatic.

The sludge filtration unit 112 may also output the processed wastewater 102 via the first water output 116, which may be controlled by the computer 158. For example, the computer 158 opens the first water output 116 to enable the sludge filtration unit 112 to output the processed wastewater 102 via the first water output 116. The processed wastewater 102 may be output via the first water output 116 because the wastewater analysis unit 104 determined that the sludge filtration unit 112 can remove a sufficient amount of impurities from the wastewater 102 to enable the customer to meet a desired use standard, such as disposing of the processed wastewater 102 in an environmentally safe manner. Additionally, the processed wastewater 102 may be output by the sludge filtration unit 112 and subsequently enter the second wastewater input 118, which may be controlled by the computer 158.

The system 100 may treat the processed wastewater 102 to oxidize soluble iron and remove bacteria before the processed wastewater 102 enters the screen filtration unit 120. Bacteria present in the wastewater 102 may quickly bloom in population, even under extreme conditions of temperature, nutrient level and oxygen level. Two primary bacteria types are sulfate reducing bacteria and acid producing bacteria. Bacteria may produce slime as a byproduct of their respiration, which may quickly foul filters and membranes. Bacteria also produce acid as a byproduct which causes corrosion. Oxidizing biocides, such as chlorine and hydrogen peroxide, may damage reverse osmosis membranes. If oxidizing biocides are used, they must be removed upstream of the reverse osmosis membrane. Other options to minimize bacteria include chlorine dioxide and ozone. The system 100 may also use ozone to remove methanol, a common additive in cold weather operations, from the wastewater 102. The system 100 may use chlorine to sterilize the water as well as oxidize the soluble iron to an insoluble form, then remove the chlorine with activated carbon. The downside of the use of chlorine is the formation of tri-halo methane compounds, which are suspected carcinogens, when combined with organics. The system 100 may use ozone to minimize bacteria. The system 100 may use one or more staging tanks for iron oxidation procedure and/or disinfection with a disinfection and/or sterilent chemical (such as chlorine or ozone) where contact time for the processed wastewater 102 is relative to a measurement release index.

The processed wastewater 102 may enter the screen filtration unit 120 via the second wastewater input 118. The screen filtration unit 120 may remove another set of impurities from the processed wastewater 102. For example, the screen filtration unit 120 may include multiple Rosedale™ micro duplex bag filters that capture sediment in a settling tank.

After the screen filtration unit 120 further processes the processed wastewater 102, the screen filtration unit 120 may output impurities via the second impurities output 122. The screen filtration unit 120 may also output the processed wastewater 102 via the second water output 124, which may be controlled by the computer 158. For example, the computer 158 opens the second water output 124 to enable the screen filtration unit 120 to output the processed wastewater 102 via the second water output 124. The processed wastewater 102 may be output via the second water output 124 because the wastewater analysis unit 104 determined that the combination of the sludge filtration unit 112 and the screen filtration unit 120 can remove a sufficient amount of impurities from the wastewater 102 to enable the customer to meet a desired use standard, such as disposing of the processed wastewater 102 in an environmentally safe manner. Additionally, the processed wastewater 102 may be output by the screen filtration unit 120 and subsequently enter the third wastewater input 126, which may be controlled by the computer 158.

The processed wastewater 102 may enter the multi-media filtration unit 128 via the third wastewater input 126. The multi-media filtration unit 128 may remove yet another set of impurities from the processed wastewater 102. For example, the multi-media filtration unit 128, which includes multiple granular filters of gravel and sand, removes residual suspended solids larger than five microns and oxidized iron from the processed wastewater 102. The multi-media filtration unit 128 may pump the processed wastewater 102 through two or more sets of multi-media filtration systems with variable porosity stages set in parallel sequence combined with additional hydrocarbon removal systems. The processed wastewater 102 exiting the multi-media filtration unit 128 may be sampled before being released to the next stage of the process.

After the multi-media filtration unit 128 processes the processed wastewater 102, the multi-media filtration unit 128 may output impurities via the third impurities output 130. The multi-media filtration unit 128 may also output the processed wastewater 102 via the third water output 132, which may be controlled by the computer 158. For example, the computer 158 opens the third water output 132 to enable the multi-media filtration unit 128 to output the processed wastewater 102 via the third water output 132. The processed wastewater 102 may be output via the third water output 132 because the wastewater analysis unit 104 determined that the combination of the sludge filtration unit 112, the screen filtration unit 120, and the multi-media filtration unit 128 can remove a sufficient amount of impurities from the wastewater 102 to enable the customer to meet a desired use standard, such as reusing the processed wastewater 102 in oil and natural gas exploration and production. Additionally, the processed wastewater 102 may be output by the multi-media filtration unit 128 and subsequently enter the fourth wastewater input 134, which may be controlled by the computer 158.

The processed wastewater 102 may enter the soluble hydrocarbon filtration unit 136 via the fourth wastewater input 134. The soluble hydrocarbon filtration unit 136 may remove yet a further set of impurities from the wastewater 102. For example, the activated carbon filtration unit 136 includes a 2,000 pound carbon bed that removes organics, bleach, and dissolved hydrocarbons of high molecular weight from the processed wastewater 102. The processed wastewater 102 exiting the soluble hydrocarbon filtration unit 136 may be sampled before being released to the next stage of the process. Similarly, the processed wastewater 102 may be sampled after exiting any of the filtration units 112, 120, 128, 144, and 152. Any of the filtration units 112, 120, 128, 144, and 152 may include a self-cleaning system that operates automatically or partially automatically. For example, the sludge filtration unit 112 may use a back flow through system or unit for self-cleaning. A back flow through system or unit may add disinfectants to clean any of the filtration units 112, 120, 128, 144, and 152.

After the soluble hydrocarbon filtration unit 136 further processes the processed wastewater 102, the soluble hydrocarbon filtration unit 136 may output impurities via the fourth impurities output 138. The soluble hydrocarbon filtration unit 136 may also output the processed wastewater 102 via the fourth water output 140, which may be controlled by the computer 158. For example, the computer 158 may control the fourth water output 140 to reduce or increase the rate at which the soluble hydrocarbon filtration unit 136 outputs the processed wastewater 102 via the fourth water output 140. The processed wastewater 102 may be output via the fourth water output 140 because the wastewater analysis unit 104 determined that the combination of the sludge filtration unit 112, the screen filtration unit 120, the multi-media filtration unit 128, and the soluble hydrocarbon filtration unit 136 can remove a sufficient amount of impurities from the wastewater 102 to enable the customer to meet a desired use standard, such as reusing the processed wastewater 102 in oil and natural gas exploration and production. Additionally, the processed wastewater 102 may be output by the soluble hydrocarbon filtration unit 136 and subsequently enter the fifth wastewater input 142, which may be controlled by the computer 158.

The use of some of the filtration units 112, 120, 138, and 136 may be replaced through the use of a silicon carbide filter if the use of the silicon carbide filter is not too expensive. The processed wastewater 102 may be tested, manually and/or by the computer 158, at any point in the system 100 for quality assurance or quality control purposes to adjust dosages of treatment chemicals and inhibitors, and to check the process removal efficiency, e.g., conductivity, chlorides, hardness, silica, sulfate, barium, iron, etc. The system 100 may have instrumentation to alarm and shut down the process if set parameters are exceeded, e.g., pH, chemical feed rate and turbidity, which may result in dumping the wastewater 102 when the process does not function sufficiently to prevent damage to the downstream sand/carbon/cartridge filters, as well as the membranes. The computer 158 may monitor and/or control any of the elements 102-156 for maintenance and/or safety reasons. For example, the computer 158 may output adjustments to any of the elements 102-156 to regulate various conditions and/or wastewater characteristics, such as maintaining the turbidity and pH of the processed wastewater 102 at a desired constant or within a desired range. The computer 158 may also provide information about any of the monitoring and/or control of any of the elements 102-156 to a system operator.

The combination of the sludge filtration unit 112, the screen filtration unit 120, the multi-media filtration unit 128, and the soluble hydrocarbon filtration unit 136 can remove a sufficient amount of impurities from the wastewater 102 to enable the customer to further process the wastewater 102 through the ultrafiltration unit 144 and the reverse osmosis filtration unit 152 or through any thermal filtration unit or microwave filtration unit. The possibility of the processed wastewater damaging the membranes of the ultrafiltration filtration unit 144 and the reverse osmosis filtration unit 152 may be greatly reduced by the pre-treatment of the processed wastewater through the filtration units 112, 120, 128, and 136.

The membranes of the ultrafiltration unit 144 and the reverse osmosis filtration unit 152 have small pores that may become clogged due to scaling, which may slow down the flow rate of the processed wastewater 102. Therefore, the system 100 may pump the wastewater 102 to a staging tank for final testing regarding membrane scaling and the addition of acid, such as sulfuric acid, metered by pH instrumentation before release to the membranes of the ultrafiltration unit 144 and the reverse osmosis filtration unit 152. Adding sulfuric acid or hydrochloric acid may dissolves sealants in the processed wastewater 102. The system 100 may also add carbonates to the processed wastewater 102 before release to the membranes of the ultrafiltration unit 144.

The system 100 may treat dissolved solids such as calcium and magnesium by adding metered amounts of hydrochloric or sulfuric acid upstream of the reverse osmosis filtration unit 152 to maintain a low pH (between 5.0 and 6.5) that does not allow scale to form. If the hardness of the processed wastewater 102 is excessively high, the system 100 may reduce the hardness via a water softening process, such as “cold-lime softening,” whereby alkalinity is added to the processed wastewater 102 to drop out the hardness as a solid that requires disposal. The system 100 may treat dissolved iron by oxidizing the iron to convert the iron from a soluble form (Fe+2) to an insoluble form (Fe+3) and then filter the iron solids. The system 100 may treat dissolved solids such as barium, strontium, sulfate, and silica by adding scale inhibitors and/or dispersants upstream of the reverse osmosis filtration unit 152 to chemically modify the dissolved ions to slow their precipitation reactions. The system 100 may also use cold lime softening to remove barium, strontium, sulfate, and silica. The system 100 may treat dissolved heavy metals by adding alkalinity to elevate the pH to the point of precipitation to precipitate the ions out of the processed wastewater 102.

Before the processed wastewater 102 enters the ultrafiltration filtration unit 144, the system 100 may further process the processed wastewater 102 through a five micron filtration unit. The processed wastewater 102 may enter the ultrafiltration filtration unit 144 via the fifth wastewater input 142. The possibility of the processed wastewater damaging the membranes of the ultrafiltration filtration unit 144 may be greatly reduced by the pre-treatment of the processed wastewater by the combination of the sludge filtration unit 112, the screen filtration unit 120, the multi-media filtration unit 128, and the soluble hydrocarbon filtration unit 136. The ultrafiltration filtration unit 144 may remove still further impurities from the wastewater 102. For example, the ultrafiltration filtration unit 144 removes suspended solids and solutes of high molecular weight from the processed wastewater 102 at a rate of 250 gallons per minute. One of skill in the art will recognize that any flow rates described as examples may vary widely based on a variety of reasons and condition

After the ultrafiltration filtration unit 144 processes the wastewater 102, the ultrafiltration filtration unit 144 may output impurities via the fifth impurities output 146. The ultrafiltration filtration unit 144 may also output the processed wastewater 102 via the fifth water output 148, which may be controlled by the computer 158. For example, the computer 158 opens the fifth water output 148 to enable the ultrafiltration filtration unit 144 to output the processed wastewater 102 via the fifth water output 148. The processed wastewater 102 may be output via the fifth water output 148 because the wastewater analysis unit 104 determined that the combination of the sludge filtration unit 112, the screen filtration unit 120, the multi-media filtration unit 128, the soluble hydrocarbon filtration unit 136, and the ultrafiltration filtration unit 144 can remove a sufficient amount of impurities from the wastewater 102 to enable the customer to meet a desired use standard, such as using the processed wastewater 102 as potable water. Additionally, the processed wastewater 102 may be output by the ultrafiltration filtration unit 144 and subsequently enter the sixth wastewater input 150, which may be controlled by the computer 158.

Before the processed wastewater 102 enters the reverse osmosis filtration unit 152, the system 100 may further process the processed wastewater 102 through a five micron mycelx filtration unit. The processed wastewater 102 may enter the reverse osmosis filtration unit 152 via the sixth wastewater input 150. The possibility of the processed wastewater damaging the membranes of the reverse osmosis filtration unit 152 may be greatly reduced by the pre-treatment of the processed wastewater by the combination of the sludge filtration unit 112, the screen filtration unit 120, the multi-media filtration unit 128, and the soluble hydrocarbon filtration unit 136. The reverse osmosis filtration unit 152 may remove still further impurities from the wastewater 102. For example, the reverse osmosis filtration unit 152 removes solute that includes chlorine from the processed wastewater 102 at a rate of 250 gallons per minute.

After the reverse osmosis filtration unit 152 processes the wastewater 102, the reverse osmosis filtration unit 152 may output impurities via the sixth impurities output 154. The reverse osmosis filtration unit 152 may also output the processed wastewater 102 via the sixth water output 156, which may be controlled by the computer 158. For example, the computer 158 opens the sixth water output 156 to enable the reverse osmosis filtration unit 152 to output the processed wastewater 102 via the sixth water output 156. The processed wastewater 102 may output via the sixth water output 156 because the wastewater analysis unit 104 determined that the combination of the sludge filtration unit 112, the screen filtration unit 120, the multi-media filtration unit 128, the soluble hydrocarbon filtration unit 136, the ultrafiltration filtration unit 144, and the reverse osmosis filtration unit 152 can remove a sufficient amount of impurities from the wastewater 102 to enable the customer to meet a desired use standard, such as using the processed wastewater 102 as drinking water. Oil and gas production companies may use embodiments of the present disclosure to recycle water at or below current disposal costs, protect the environment and health of citizens; reduce the volumes of fresh water needed for exploration and production, overcome negative public perceptions, and improve their public image

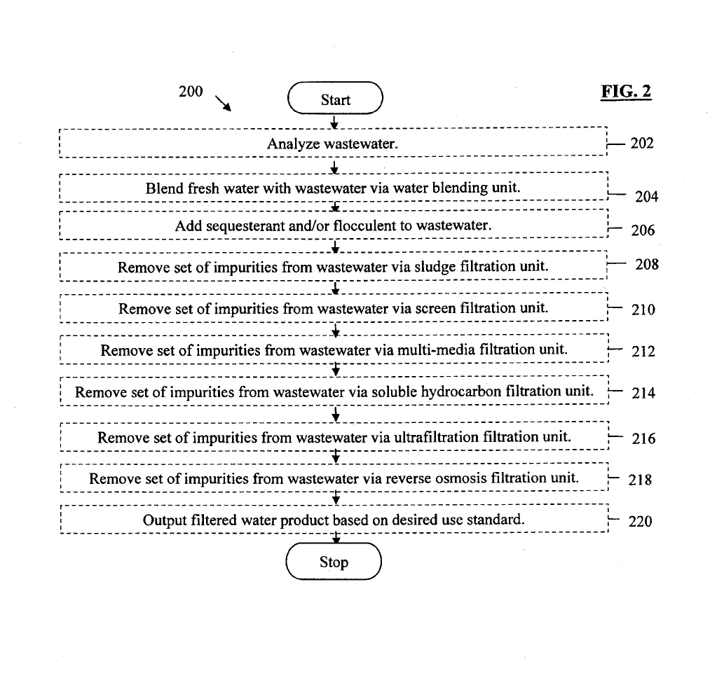

FIG. 2 depicts a flowchart of an exemplary method 200 of the present invention. Executing the method 200 may enable economically viable wastewater purification based on a customer's desired use standard.

In box 202, wastewater is optionally analyzed. For example, the wastewater analysis unit 104 analyzes the wastewater 102 to determine the levels of hydrocarbons, suspended solids, dissolved solids, and bacteria present in the wastewater 102.

In box 204, fresh water is optionally blended with wastewater via water blending unit. For example, the water blending unit 106 blends the fresh water 108 with the wastewater 102 to allow a higher flow rate of the processed wastewater 102 and protect filters by affecting the overall level of impurities in the processed wastewater 102.

In box 206, a coagulant and/or a flocculent is optionally added to wastewater. For example, the sludge filtration unit 112 is a dissolved air flotation unit that adds 1 to 10 drops of ferric chloride per gallon of the wastewater 102 to the wastewater 102.

In box 208, a set of impurities is optionally removed from wastewater via a sludge filtration unit. For example, the sludge filtration unit 112 is a dissolved air flotation unit that removes sludge that includes entrained hydrocarbons from the wastewater 102.

In box 210, a set of impurities is optionally removed from wastewater via a screen filtration unit. For example, the screen filtration unit 120 is a Rosedale™ bag filter that removes sediment from the processed wastewater 102.

In box 212, a set of impurities is optionally removed from wastewater via a multi-media filtration unit. For example, the multi-media filtration unit 128 is a gravel and sand filter that removes residual suspended solids larger than five microns and oxidized iron from the processed wastewater 102.

In box 214, a set of impurities is optionally removed from wastewater via a soluble hydrocarbon filtration unit. For example, the soluble hydrocarbon filtration unit 136 may be an activated carbon filtration unit which removes organics, chlorine, and dissolved hydrocarbons of high molecular weight from the processed wastewater 102.

In box 216, a set of impurities is optionally removed from wastewater via an ultrafiltration filtration unit. For example, the ultrafiltration filtration unit 144 removes suspended solids and solutes of high molecular weight from the processed wastewater 102.

In box 218, a set of impurities is optionally removed from wastewater via a reverse osmosis filtration unit. For example, the reverse osmosis filtration unit 152 removes solute that includes chlorine from the processed wastewater 102.

In box 220, a filtered water product is optionally output based on a desired use standard. For example, the system 100 outputs drinking water. The system 100 does not have to remove chloride from the wastewater 102 if the processed wastewater 102 is to be reused for hydraulic fracturing, but the system may remove chloride from the wastewater 102 if the processed wastewater 102 is to be disposed of on land or in water. Desalination may not be required if the end-use of the water is fracturing or drilling, whereby salt is added to prevent swelling of formation clays which produce wellbore damage and reduced production.

The invention being thus described, it will be obvious that the same may be varied in many ways. Embodiments of the present disclosure may be customized for each customer based on the levels of impurities in the customer's wastewater and/or the customers' desired end product specifications. Such variations are not to be regarded as a departure from the spirit and scope of the invention and all such modifications as would be obvious to one skilled in the art are intended to be included within the scope of the system, method, or computer program product described

What is claimed:

1. A system for wastewater purification, the system comprising:
a sludge filtration unit that removes a first set of impurities from wastewater, wherein said impurities comprise at least one of hydrocarbons, suspended solids, and dissolved solids;
a screen filtration unit that removes a second set of impurities from said wastewater;
a multi-media filtration unit that removes a third set of impurities from said wastewater; and
a soluble hydrocarbon filtration unit that removes a fourth set of impurities from said wastewater.

2. The system of claim 1, wherein said sludge filtration unit comprises at least one of a dissolved air flotation filtration unit, a clay filtration unit, and an ion exchange filtration unit.

3. The system of claim 2, wherein at least one of said dissolved air flotation filtration unit, a batch mixer, a chemical blender, a chemical pump, and a screen processor, adds at least one of a coagulant and a flocculent to said wastewater.

4. The system of claim 3, wherein said at least one of said coagulant and said flocculent is selected from at least one of ferric chloride, aluminum chlorohydrate, and aluminum sulfate.

5. The system of claim 1 wherein said soluble hydrocarbon filtration unit comprises an activated carbon filtration unit.

6. The system of claim 1 wherein said wastewater comprises at least one of oilfield flowback water, oilfield produced water, oilfield pit water, and blended fresh water.

7. The system of claim 1, further comprising at least one of a water blending unit to blend fresh water with said wastewater and a filter press to reclaim a commercial hydrocarbon product from said wastewater.

8. The system of claim 1, further comprising an ultrafiltration filtration unit that removes a fifth set of impurities from said wastewater.

9. The system of claim 8, further comprising a reverse osmosis filtration unit that removes a sixth set of impurities from said wastewater.

10. The system of claim 9, wherein removal of at least one of said first set of impurities, said second set of impurities, said third set of impurities, said fourth set of impurities, said fifth set of impurities, and said sixth set of impurities is based on an analysis of said wastewater.

11. The system of claim 1, wherein an amount of at least one of a coagulant and a flocculent is selected based upon an analysis of said wastewater.

12. The system of claim 1, wherein an amount of at least one of a coagulant and a flocculent is selected based upon a water output requested by a user.

13. A method for wastewater purification, the method comprising:
removing a first set of impurities from wastewater via a screen filtration unit, wherein said impurities comprise at least one of hydrocarbons, suspended solids, and dissolved solids;
removing a second set of impurities from said wastewater via a multi-media filtration unit; and
removing a third set of impurities from said wastewater via a soluble hydrocarbon filtration unit.

14. The method of claim 13, further comprising removing a fourth set of impurities from said wastewater via a sludge filtration unit.

15. The method of claim 14, wherein said sludge filtration unit comprises at least one of a dissolved air flotation filtration unit, a clay filtration unit, and an ion exchange filtration unit.

16. The method of claim 15, further comprising adding at least one of a coagulant and a flocculent to said wastewater via at least one of said dissolved air flotation filtration unit, a batch mixer, a chemical blender, a chemical pump, and a screen processor.

17. The method of claim 16, wherein said at least one of said coagulant and said flocculent is selected from at least one of ferric chloride, aluminum chlorohydrate, and aluminum sulfate.

18. The method of claim 16, further comprising selecting an amount of said at least one of said coagulant and said flocculent based upon an analysis of said wastewater.

19. The method of claim 16, further comprising selecting an amount of said at least one of said coagulant and said flocculent based upon a water output requested by a user.

20. The method of claim 13, wherein said soluble hydrocarbon filtration unit comprises an activated carbon filtration unit.

21. The method of claim 13, wherein said wastewater comprises at least one of oilfield flowback water, oil field produced water, oilfield pit water and blended fresh water.

22. The method of claim 13, further comprising at least one of blending fresh water with said wastewater via a water blending unit and reclaiming a commercial hydrocarbon product from said wastewater via a filter press.

23. The method of claim 13, further comprising removing a fifth set of impurities from said wastewater via an ultrafiltration filtration unit.

24. The method of claim 23, further comprising removing a sixth set of impurities from said wastewater via a reverse osmosis filtration unit

25. The method of claim 24, wherein removing at least one of said first set of impurities, said second set of impurities, said third set of impurities, said fourth set of impurities, said fifth set of impurities, and said sixth set of impurities is based on an analysis of said wastewater.

26. The method of claim 24, further comprising outputting a filtered water product based on a desired use standard in response to removing of at least one of said first set of impurities, said second set of impurities, said third set of impurities, said fourth set of impurities, said fifth set of impurities, and said sixth set of impurities.

27. A system for wastewater purification, the system comprising:
a processor;
a memory; and
a management component stored in the memory, wherein said management component is executed by said processor to:
direct wastewater to a sludge filtration unit to remove a first set of impurities from said wastewater, wherein said impurities comprise at least one of hydrocarbons, suspended solids, and dissolved solids;
direct said wastewater to a multi-media filtration unit to remove a second set of impurities from said wastewater; and
direct said wastewater to a soluble hydrocarbon filtration unit to remove a third set of impurities from said wastewater.

28. The system of claim 27, wherein said management component is further executed by said processor to direct said wastewater to a screen filtration unit to remove a fourth set of impurities from said wastewater.

29. The system of claim 27, wherein said sludge filtration unit comprises at least one of a dissolved air flotation filtration unit, a clay filtration unit, and an ion exchange filtration unit.

30. The system of claim 29, wherein said management component is further executed by said processor to instruct at least one of said dissolved air flotation filtration unit, a batch mixer, a chemical blender, a chemical pump, and a screen processor to add at least one of a coagulant and a flocculent to said wastewater.

31. The system of claim 30, wherein said at least one of said coagulant and said flocculent is selected from at least one of ferric chloride, aluminum chlorohydrate, and aluminum sulfate.

32. The system of claim 30, wherein an amount of said at least one of said coagulant and said flocculent is selected based upon an analysis of said wastewater.

33. The system of claim 30, wherein an amount of said at least one of said coagulant and said flocculent is selected based upon a water output requested by a user.

34. The system of claim 27 wherein said soluble hydrocarbon filtration unit comprises an activated carbon filtration unit.

35. The system of claim 27 wherein said wastewater comprises at least one of oilfield flowback water, oil field produced water, oilfield pit water, and blended fresh water.

36. The system of claim 27, further comprising at least one of a water blending unit to blend fresh water with said wastewater and a filter press to reclaim a commercial hydrocarbon product from said wastewater.

37. The system of claim 27, wherein said management component is further executed by said processor to direct said wastewater to an ultrafiltration filtration unit to remove a fifth set of impurities from said wastewater.

38. The system of claim 37, wherein said management component is further executed by said processor to direct said wastewater to a reverse osmosis filtration unit to remove a sixth set of impurities from said wastewater.

39. The system of claim 38, wherein removal of at least one of said first set of impurities, said second set of impurities, said third set of impurities, said fourth set of impurities, said fifth set of impurities, and said sixth set of impurities is based on an analysis of said wastewater.

40. A system for wastewater purification, the system comprising:
a sludge filtration unit that removes a first set of impurities from wastewater, wherein said impurities comprise at least one of hydrocarbons, suspended solids, and dissolved solids;
a screen filtration unit that removes a second set of impurities from said wastewater; and
a soluble hydrocarbon filtration unit that removes a third set of impurities from said wastewater.

41. The system of claim 40, further comprising a multi-media filtration unit that removes a fourth set of impurities from said wastewater

42. The system of claim 40, wherein said sludge filtration unit comprises at least one of a dissolved air flotation filtration unit, a clay filtration unit, and an ion exchange filtration unit

43. The system of claim 40, wherein at least one of said dissolved air flotation filtration unit, a batch mixer, a chemical blender, a chemical pump, and a screen processor, adds at least one of a coagulant and a flocculent to said wastewater.

44. The system of claim 43, wherein an amount of said at least one of said coagulant and said flocculent is selected based upon an analysis of said wastewater.

45. The system of claim 43, wherein an amount of said at least one of said coagulant and said flocculent is selected based upon a water output requested by a user.

46. The system of claim 40, wherein said soluble hydrocarbon filtration unit comprises an activated carbon filtration unit.

47. A system for wastewater purification, the system comprising:
a sludge filtration unit that removes a first set of impurities from wastewater, wherein said impurities comprise at least one of hydrocarbons, suspended solids, and dissolved solids;
a screen filtration unit that removes a second set of impurities from said wastewater; and
a multi-media filtration unit that removes a third set of impurities from said wastewater.

48. The system of claim 47, further comprising a soluble hydrocarbon filtration unit that removes a fourth set of impurities from said wastewater.

49. The system of claim 48, wherein said soluble hydrocarbon filtration unit comprises an activated carbon filtration unit.

50. The system of claim 47, wherein said sludge filtration unit comprises at least one of a dissolved air flotation filtration unit, a clay filtration unit, and an ion exchange filtration unit.

51. The system of claim 50, wherein at least one of said dissolved air flotation filtration unit, a batch mixer, a chemical blender, a chemical pump, and a screen processor, adds at least one of a coagulant and a flocculent to said wastewater.

52. The system of claim 51, wherein an amount of said at least one of said coagulant and said flocculent is selected based upon an analysis of said wastewater.

53. The system of claim 51, wherein an amount of said at least one of said coagulant and said flocculent is selected based upon a water output requested by a user.
